(19) United States
(12) Patent Application Publication
(10) Pub. No.: US 2024/0027130 A1
(43) Pub. Date: Jan. 25, 2024

(54) Drainage System

(71) Applicant: NuBlu Innovations, LLC, Center, TX (US)

(72) Inventors: Ravi Sudhakar Vemulapalli, Katy, TX (US); Robert Meredith Harman, JR., Sugar Grove, WV (US); Robert J. Woodman, Gorham, ME (US)

(21) Appl. No.: 18/356,991

(22) Filed: Jul. 21, 2023

Related U.S. Application Data
(60) Provisional application No. 63/392,688, filed on Jul. 27, 2022.
(60) Provisional application No. 63/391,272, filed on Jul. 21, 2022.

(51) Int. Cl. F26B 9/10; E02B 11/00

(52) U.S. Cl. CPC F26B 9/10; E02B 11/005; F26B 2200/14

(57) ABSTRACT

A frac sand drainage system comprising a permeable top surface, a cellular confinement layer, a fabric coated geo-grid, one or more geotextile fabric layer, one or more sand layer, one more drainage blocks, and a watertight liner.

### CROSS-REFERENCE TO RELATED APPLICATIONS

This application claims priority to and the benefit of the filing date of U.S. Provisional Application Nos. 63/392,688, filed Jul. 27, 2022, and 63/391,272, filed Jul. 21, 2022, each of which is hereby incorporated by reference herein in its entirety.

### BACKGROUND OF THE INVENTION

### Field of the Invention

The present invention relates to the field of drainage systems, especially drainage systems used to dry sand, for example, frac sand.

### Description of Related Art

During the hydraulic fracturing process used in oil and gas extraction, liquid slurries are injected into the ground at high pressures, causing fractures in the layers of rock (such as shale). If not supported, these fractures will close, preventing the extraction of the oil or gas. To prevent collapse of the fractures, the liquid slurries pumped into oil/gas wells often comprise sand to fill in the fractures. Each well requires a large quantity of sand.

After frac sand is mined, the sand is typically processed before it is added to a fracking liquid. As part of the processing, the sand is washed and then dried. One method of drying the frac sand involves storing the sand in large piles and allowing the water to drain through. Drainage systems below the sand piles should be capable of supporting the weight of the wet sand and equipment used to transport and pile it. Example drainage systems can be found in U.S. Pat. No. 10,634,4217 and U.S. Pat. No. 11,092,380, incorporated by reference herein in their entireties.

There remains a need for drainage systems capable of decanting washed sand storage piles as quickly as possible while keeping installation and materials costs low. The drainage systems of the present invention can be installed at a lower cost and are more robust than other drainage systems on the market.

### SUMMARY OF THE INVENTION

The drainage systems described herein are capable of decanting washed sand storage piles. The systems are designed for a wet sand production rate of up to about 800 tons per hour. The systems are able to remain structurally sound through temperature swings, such as those typical of desert climates.

Aspects of the invention include Aspect 1, a drainage system comprising one or more of a permeable top surface, a cellular confinement layer, a fabric coated geo-grid, one or more geotextile fabric layer, one or more sand or aggregate (such as small stones) layer, one more drainage blocks, and a watertight liner, optionally with a fabric layer above and/or below the liner for cushion.

Aspect 2 is the system of Aspect 1, wherein the one or more drainage blocks are located above the watertight liner.

Aspect 3 is the system of Aspect 1 or 2, wherein the one or more drainage blocks extend completely across the width of the drainage system.

Aspect 4 is the system of any of Aspects 1-3, wherein the one or more drainage blocks cover an area less than the total area of the drainage system.

Aspect 5 is the system of any of Aspects 1-4, wherein a first sand layer is disposed between the one or more drainage blocks and the cellular confinement layer.

Aspect 6 is the system of any of Aspects 1-5, wherein the fabric coated geo-grid is disposed between a first sand layer and the cellular confinement layer.

Aspect 7 is the system of any of Aspects 1-6, wherein a first sand layer is disposed between a geotextile fabric layer and the fabric coated geo-grid, wherein the geotextile fabric layer comprises a woven geotextile fabric.

Aspect 8 is the system of any of Aspects 1-7, wherein the permeable top surface comprises polyethylene-based panels.

Aspect 9 is the system of any of Aspects 1-8, wherein the polyethylene-based panels are divided into several cells.

Aspect 10 is the system of any of Aspects 1-9, wherein the polyethylene-based panels comprise one or more walls, dividing the polyethylene-based panels into cells.

Aspect 11 is the system of any of Aspects 1-10, wherein the one or more walls have a thickness of about 0.2 inches.

Aspect 12 is the system of any of Aspects 1-11, wherein the watertight liner is an HDPE or PVC liner, such as a 20 Mil, or 40 Mil, or 60 Mil PVC liner.

Aspect 13 is the system of any of Aspects 1-12, further comprising first and second geotextile fabric layers disposed above and below the watertight liner.

Aspect 14 is the system of any of Aspects 1-13, wherein the first and second geotextile fabric layers comprise non-woven geotextile fabric.

Aspect 15 is the system of any of Aspects 1-14, wherein the one or more geotextile fabric layer is composed of polypropylene, polyester, polyethylene, or nylon.

Aspect 16 is the system of any of Aspects 1-15, further comprising a woven geotextile fabric layer disposed between the one or more drainage blocks and a first sand layer.

Aspect 17 is the system of any of Aspects 1-16, wherein the cellular confinement layer is filled with sand or aggregates (such as small stones).

Aspect 18 is the system of any of Aspects 1-17, wherein the one or more drainage blocks are about 90% void space.

Aspect 19 is the system of any of Aspects 1-18, wherein the first sand layer has a thickness of about 4 inches to 6 inches.

Aspect 20 is the system of any of Aspects 1-19, further comprising one or more drain pipe.

Aspect 21 is the system of any of Aspects 1-20, further comprising one or more sump.

Aspect 22 is the system of any of Aspects 1-21, wherein the permeable top surface is filled with sand or aggregates (such as small stones).

Aspect 23 is the system of any of Aspects 1-22, wherein the one or more drainage blocks have a height of about 2 inches.

Aspect 24 is the system of any of Aspects 1-23, wherein the cellular confinement layer has a height of about 8 inches.

Aspect 25 is a drainage system comprising a first layer comprising a wear surface, a second layer comprising a cellular confinement system, a third layer comprising a fabric covered geo-grid, a fourth layer comprising sand, a fifth layer comprising drainage blocks covered with a woven geotextile fabric, and a sixth layer comprising a watertight liner.

Aspect 26 is the system of Aspect 25, wherein the sixth layer comprises one or more fabric layers above and/or below the liner, such as for cushion.

Aspect 27 is the system of Aspect 25 or 26, wherein the fabric is non-woven geotextile fabric.

Aspect 28 is the system of any of Aspects 25-27, wherein the liner is an HDPE or PVC liner, such as a 20 Mil, or 40 Mil, or 60 Mil PVC liner.

Aspect 29 is the system of any of Aspects 25-28, wherein the liner comprises 60 mil PVC.

Aspect 30 is the system of any of Aspects 25-29, wherein one or more of the first, second, fourth, or fifth layers has a height of up to about 4 inches, such as up to about 1, 2, or 3 inches.

Aspect 31 is the system of any of Aspects 25-30, one or more of the first, second, fourth, or fifth layers has a height of up to about 10 inches, such as up to about 2, 3, 4, 5, 6, 7, 8, or 9 inches.

Aspect 32 is the system of any of Aspects 25-31, wherein one or more of the first, second, fourth, or fifth layers has a height of up to about 16 inches, such as up to about 2, 4, 6, 8, 10, 12, or 14 inches.

Aspect 33 is the system of any of Aspects 25-32, wherein the cellular confinement system is filled with sand or aggregates (such as small stones).

Aspect 34 is the system of any of Aspects 25-33, wherein the wear surface comprises a permeable paver grid system.

Aspect 35 is the system of any of Aspects 25-34, wherein the permeable paver grid system is filled with or is replaced by sand or aggregates (such as small stones).

Aspect 36 is the system of any of Aspects 25-35, wherein the wear surface is perforated.

Aspect 37 is the system of any of Aspects 25-36, wherein the wear surface comprises one or more panels with a plurality of cells.

Aspect 38 is the system of any of Aspects 25-37, wherein one or more of the cells have a wall thickness of about 0.1-0.3 inches, such as about 0.2 inches.

Aspect 39 is the system of any of Aspects 25-38, wherein the fourth layer has a height of up to about 4 inches, such as up to about 1, 2, or 3 inches.

Aspect 40 is the system of any of Aspects 25-39, further comprising a woven geotextile fabric layer disposed on top of and/or along the sides of the drainage blocks.

Aspect 41 is the system of any of Aspects 25-40, wherein the fourth layer further comprises one or more drainage blocks covered in woven geotextile fabric disposed within the sand.

Aspect 42 is the system of any of Aspects 25-41, wherein two or more drainage blocks are stacked.

Aspect 43 is the system of any of Aspects 1-42, wherein the watertight liner rests on or above a surface prepared to 95% compaction.

Aspect 44 is the system of any of Aspects 1-43, wherein the watertight liner rests on or above a sloped subgrade.

### BRIEF DESCRIPTION OF THE DRAWINGS

The accompanying drawings illustrate certain aspects of implementations of the present disclosure, and should not be construed as limiting. Together with the written description the drawings serve to explain certain principles of the disclosure.

FIGS. 1A-F are illustrations of cross-sections of drainage systems according to various embodiments of the invention.

FIG. 2A is a drawing of the area in which a drainage system may be installed around a radial stacker according to an embodiment of the invention.

FIG. 2B is a drawing of the location of drainage channels in a drainage system according to an embodiment of the invention.

FIG. 2C is an illustration of the stacking of drainage blocks to prepare a drainage channel.

FIGS. 2D and 2E are images of R-Tank drainage blocks arranged side by side across the drainage field and arranged in a stacked configuration, respectively.

FIG. 3A is a drawing showing a location for the installation of a drainage system according to an embodiment of the invention.

FIG. 3B is a drawing showing the direction of the sloped subgrade and locations of various aspects of the drainage system according to an embodiment of the invention.

FIG. 3C is a drawing showing locations of drainage blocks and/or drainage channels according to an embodiment of the invention.

FIGS. 4A-D are images of example materials that can be used in the construction of a drainage system according to an embodiment of the invention, including a wear surface (4A), geocell (4B), drainage block (4C), and Fab-Grid (4D).

### DETAILED DESCRIPTION OF VARIOUS

### Embodiments of the Invention

The drainage systems described herein are capable of decanting washed sand storage piles. The systems are capable of supporting the static weight of large wet sand piles, such as those of heights of up to about 60 feet. The drainage systems are also able to withstand static and dynamic loads of wheel loaders, such as the Komatsu W500, and sheer forces of spinning wheel loader tires. The systems are designed for a wet sand production rate of up to about 800 tons per hour. The systems are capable of reducing moisture content from about 22% to about 4-5% in approximately 2 days. As is common with many drainage systems, the systems may become less effective over time due to the presence of sediment. The systems are flushable, however, should the drainage systems become less efficient due to difficult to remove sediments, such as fine clays, a new drainage system can be installed over an existing drainage system.

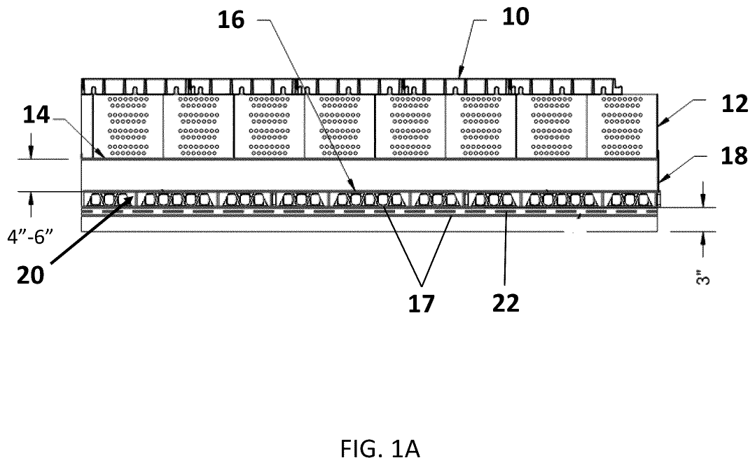

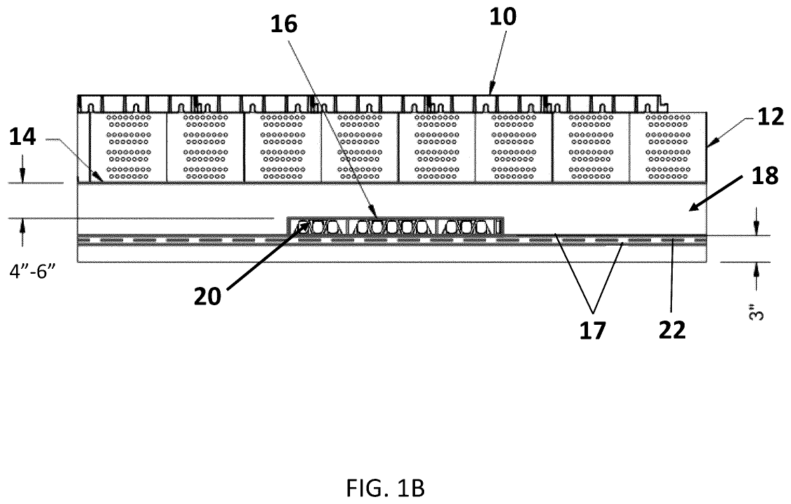

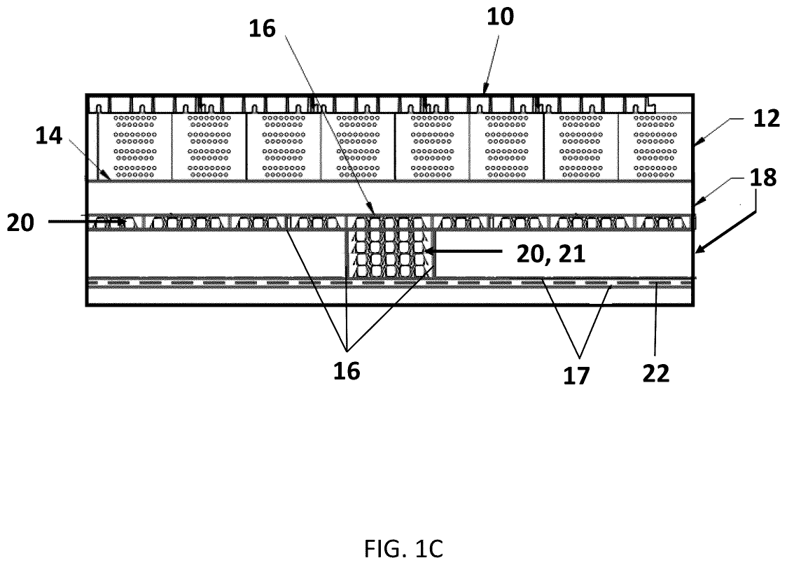

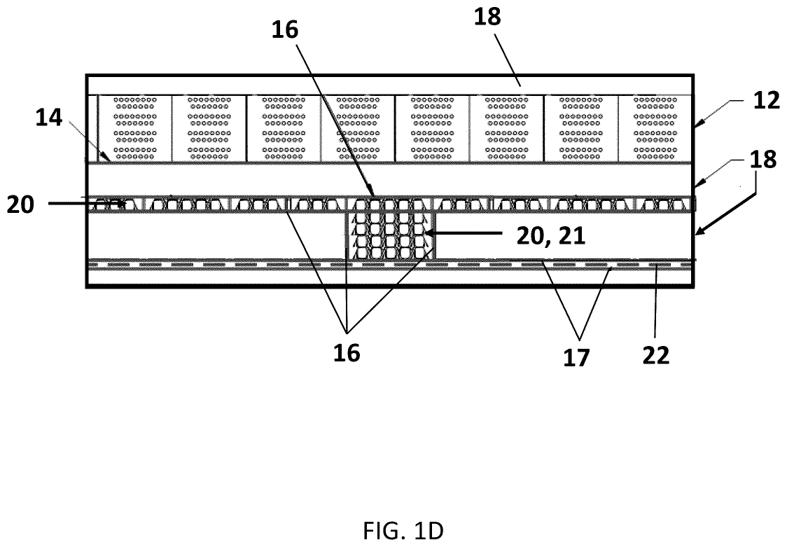

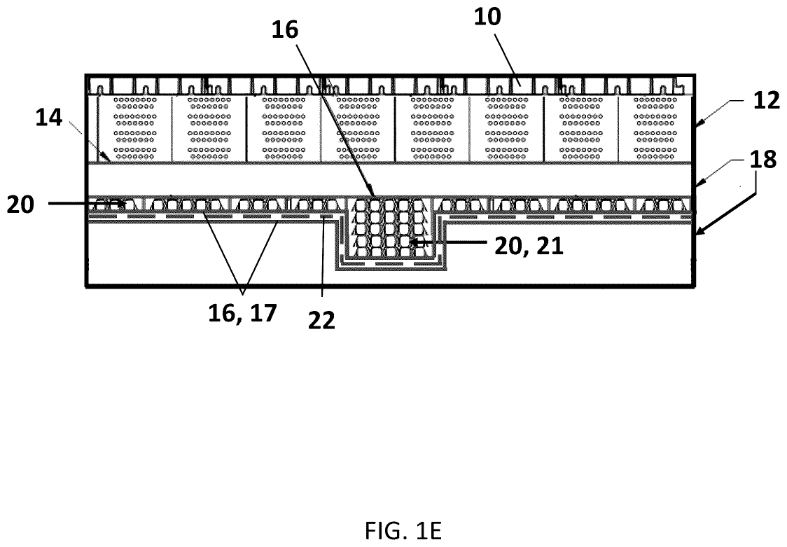

As best shown in FIGS. 1A-D, which illustrate cross sections of various example drainage systems, the drainage systems of the present invention comprise several layers. One or more layers of said drainage systems comprise one or more wear surface 10, one or more cellular confinement layer (or geo-cells) 12, one or more fabric-coated geo-grid (or fab-grid) 14, one or more woven geotextile fabric 16, one or more non-woven geotextile fabric 17, sand 18, one or more drainage blocks/panels 20, and one or more watertight liner 22. The incorporation of one or more layers of cellular confinement layer 12 increases the stability of the drainage system. Incorporation of drainage blocks/panels 20 provides an effective alternative to installation of more complex pipe systems. Wear surface 10 provides a suitable surface capable of withstanding movement of equipment, such as wheel loaders, but is optional in any embodiment herein.

According to an embodiment of the invention shown in FIG. 1A, the drainage system comprises a wear surface 10, a layer of geo-cells 12, a fabric-coated geo-grid 14, a layer of sand 18, a layer of woven geotextile fabric 16, a layer of drainage panels 20, and a watertight liner 22 sandwiched between layers of non-woven geotextile fabric 17. In this embodiment, the wear surface 10 is filled with sand or other material. The geo-cells 12, also filled with sand, have a height of about 8 inches. The sand layer 18 has a height of about 4 inches. In this particular embodiment, a plurality of drainage blocks/panels 20 are placed in a single layer which extends across the entirety of the drain area.

In another embodiment of the invention (FIG. 1B), the drainage system comprises a wear surface 10, a layer comprising cellular confinement system panels 12, a fabric-coated geo-grid 14, a layer of sand 18, woven geotextile fabric 16, drainage panels 20 disposed within the layer of sand 18, and a watertight liner 22 sandwiched between layers of non-woven geotextile fabric 17. In this embodiment, the wear surface 10 is filled with sand or other material. The cellular confinement layer 12, also filled with sand, has a height of about 8 inches. In this particular embodiment, the layer comprising drainage blocks/panels 20 does not extend across the entirety of the drain area. The top and sides of the drainage blocks/panels 20 are covered with woven geotextile fabric 16 to prevent them from filling with sand. In other embodiments, the group of drainage blocks/panels 20 is wrapped in woven geotextile fabric 16 such that the top, sides, and bottom of the group of drainage blocks/panels 20 are covered in the woven geotextile fabric 16.

In another embodiment of the invention (FIG. 1C), the drainage system comprises a wear surface 10, geo-cells 12, a fabric-coated geo-grid 14, sand 18, woven geotextile fabric 16, drainage blocks/panels 20, and a watertight liner 22 sandwiched between layers of non-woven geotextile fabric 17. In this embodiment, the wear surface 10 is filled with sand or other material. In this particular embodiment, a first drainage layer comprising drainage blocks/panels 20 extends across the entirety of the drain area. A second drainage layer comprising drainage blocks/panels 20 and sand 18 is disposed below the first layer comprising drainage blocks/panels 20. The second layer comprising drainage blocks/panels 20 and sand 18 is configured to create a drainage channel 21. The top and sides of the drainage blocks/panels 20 are covered by a layer of woven geotextile fabric 16. In other embodiments, the group of drainage blocks/panels 20 is wrapped in a layer of woven geotextile fabric 16 such that the top, sides, and bottom of the group of drainage blocks/panels 20 are covered in the woven geotextile fabric 16.

In another embodiment of the invention (FIG. 1D), the drainage system comprises the features of the embodiment shown in FIG. 1C, without a wear surface 10. In this embodiment, the cellular confinement layer 12 is covered with sand 18. Any of the drainage systems herein may optionally substitute the wear surface 10 with a layer of sand 18 or other granular material capable of supporting the material to be drained while allowing water to pass through the drainage system.

In another embodiment of the invention (FIG. 1E), the drainage system comprises a wear surface 10, geo-cells 12, a fabric-coated geo-grid 14, sand 18, woven geotextile fabric 16, non-woven geotextile fabric 17, drainage blocks/panels 20, and a watertight liner 22. In this embodiment, the wear surface 10 is filled with sand or other material. In this particular embodiment, a first drainage layer comprising drainage blocks/panels 20 extends across the entirety of the drain area. A second drainage layer comprising drainage blocks/panels 20 and sand 18 is disposed below the first layer comprising drainage blocks/panels 20. The second layer comprising drainage blocks/panels 20 and sand 18 is configured to create a drainage channel 21. The watertight liner 22 is sandwiched between layers of woven geotextile fabric 16 and/or non-woven geotextile fabric 17, and extends underneath and along the sides of the drainage channel 21 and underneath the first layer comprising drainage blocks/panels 20. In other embodiments, a layer of woven geotextile fabric 16 is disposed between the bottom of the first layer comprising drainage blocks/panels 20 and the top of the drainage channel 21.

In another embodiment of the invention (FIG. 1F), the drainage system comprises the features of the embodiment shown in FIG. 1E, without a wear surface 10. In this embodiment, the cellular confinement layer 12 is covered with sand 18. Any of the drainage systems herein may optionally substitute the wear surface 10 with a layer of sand 18 or other granular material capable of supporting the material to be drained while allowing water to pass through the drainage system.

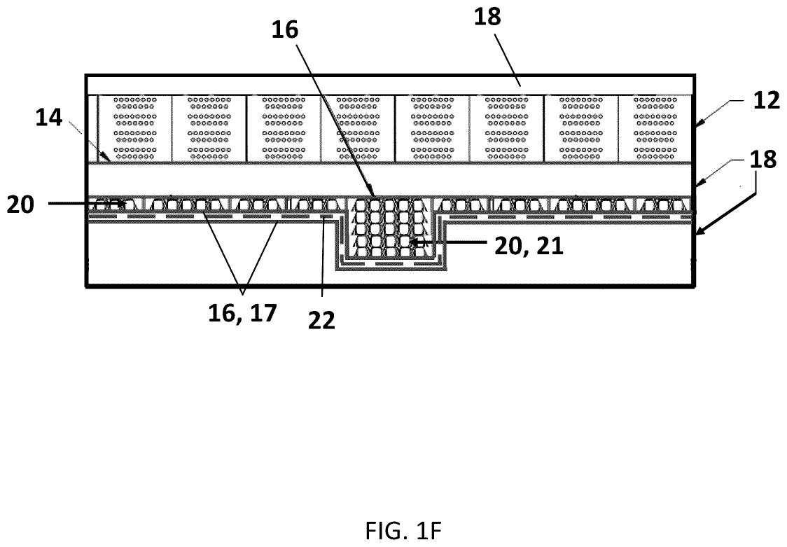

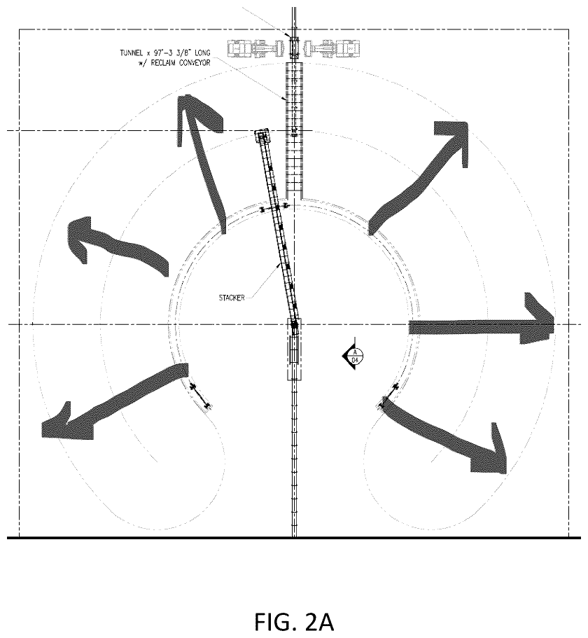

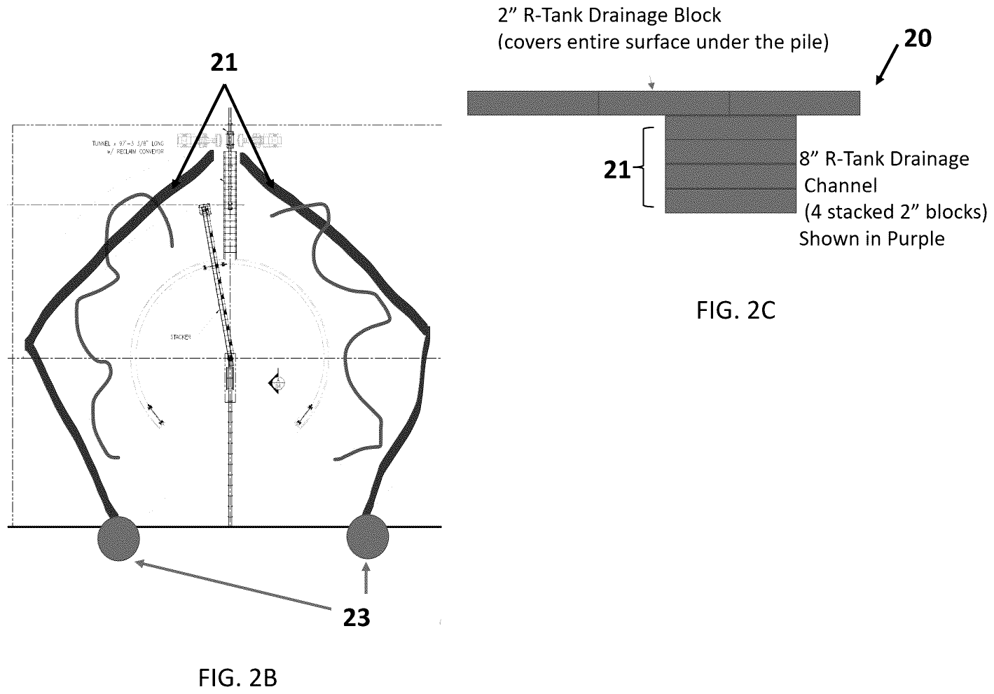

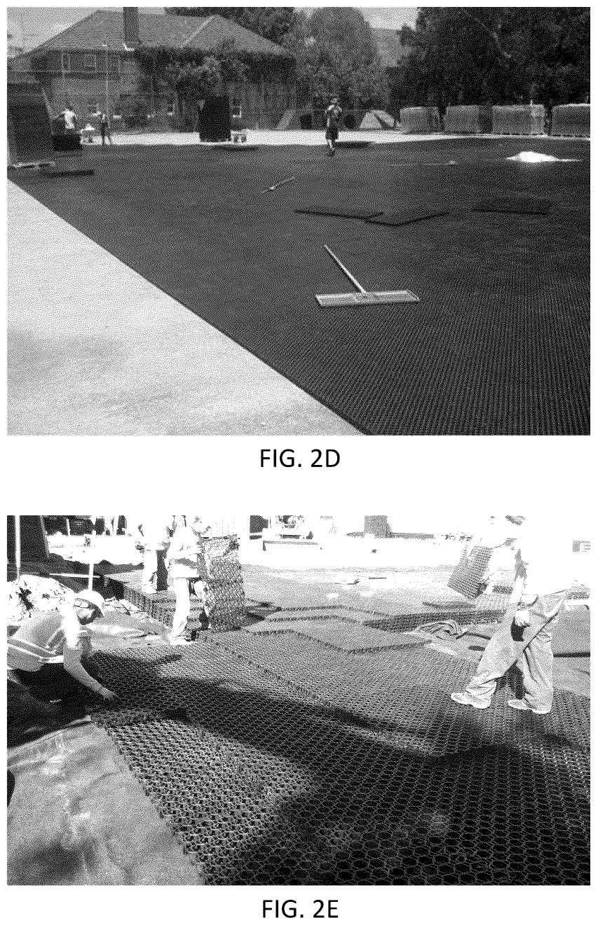

According to an embodiment of the invention, a drainage system is installed around a radial stacker (FIG. 2A). The drain is installed over a sloped subgrade prepared to at least about a 95% compaction. The subgrade slopes away from the stacker conveyer in the directions shown by the arrows in FIG. 2A.

FIG. 2B shows the drainage system layout according to an embodiment of the invention. The drainage system comprises drainage blocks 20 installed across the entire drain surface. Drainage channels 21 comprising stacks of drainage blocks 20 (FIG. 2C) are installed in the area indicated by the solid purple lines (FIG. 2B). FIGS. 2D and 2E show drainage blocks 20 arranged side by side across a drainage field and stacked, respectively. In embodiments, any number of the drainage blocks 20 can be stacked to form drainage channels 21, such as from 2-10, including 3, 4, 5, 6, 7, 8, or 9 blocks/panels arranged in a stacked configuration. The stacking can also be arranged in rows and/or complete layers across the width or area of the drainage field. In embodiments, the drainage blocks 20 are arranged in a single layer across the drainage field and disposed on top of an in communication with additional drainage blocks 20 arranged in a stacked configuration to form drainage channels 21. In such a configuration, water draining from the frac sand can pass through the drainage blocks 20 into drainage channels 21 to remove water from the system. In an embodiment of the invention, the drainage system comprises one or more sump(s) 23. In embodiments, one or more drainage channels 21 terminate at one or more sump 23.

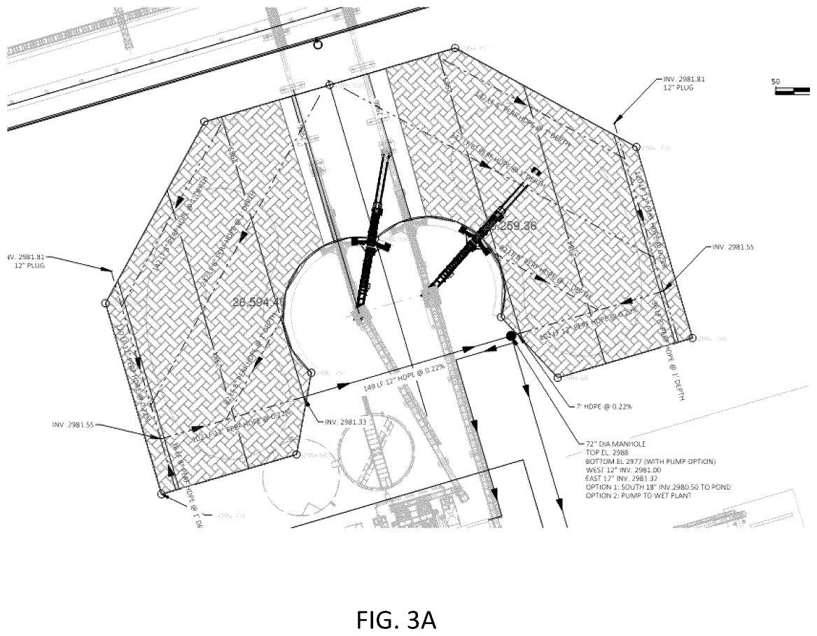

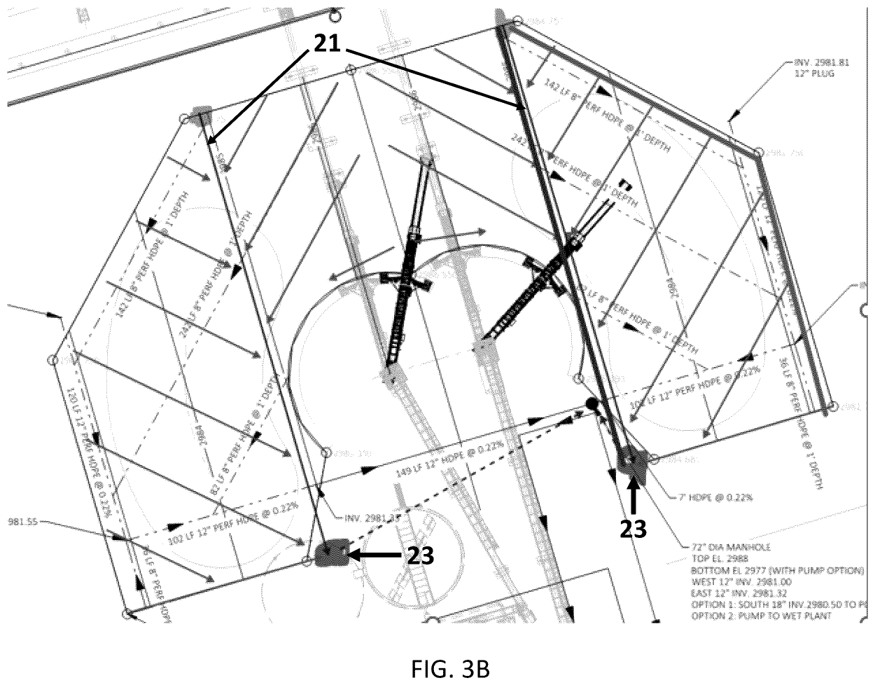

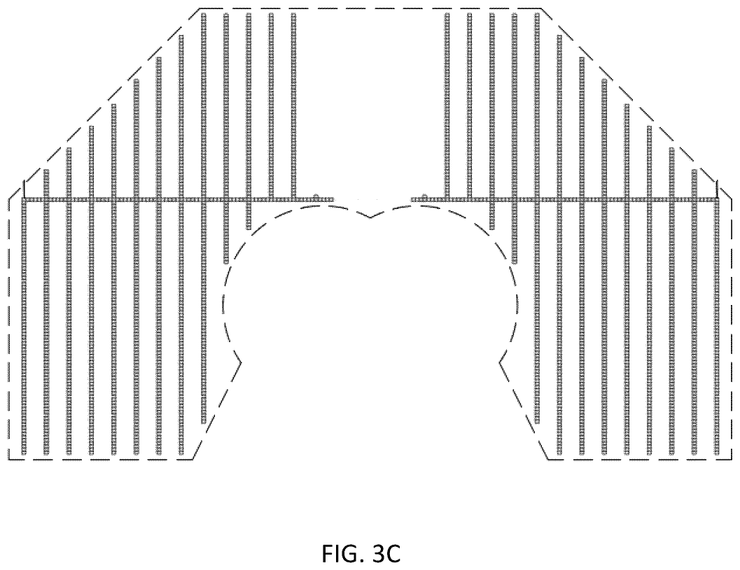

An example location for installation of a drain according to an embodiment of the invention is shown in FIG. 3A. The target area for the ˜60,000 sq ft drain is shown in red under two radial stackers.

As shown in FIG. 3B, the drain is installed over a subgrade sloped as indicated by the red arrows. In an embodiment of the invention, drainage blocks 20 are located across the entire drain area indicated in red in FIG. 3A and drainage channels 21 are disposed along the solid blue lines shown in FIG. 3B.

In an embodiment of the invention, the drainage blocks do not cover the entirety of the drain area. FIG. 3C shows an example design where the drainage blocks 20 or drainage channels 21 are installed in rows across the surface.

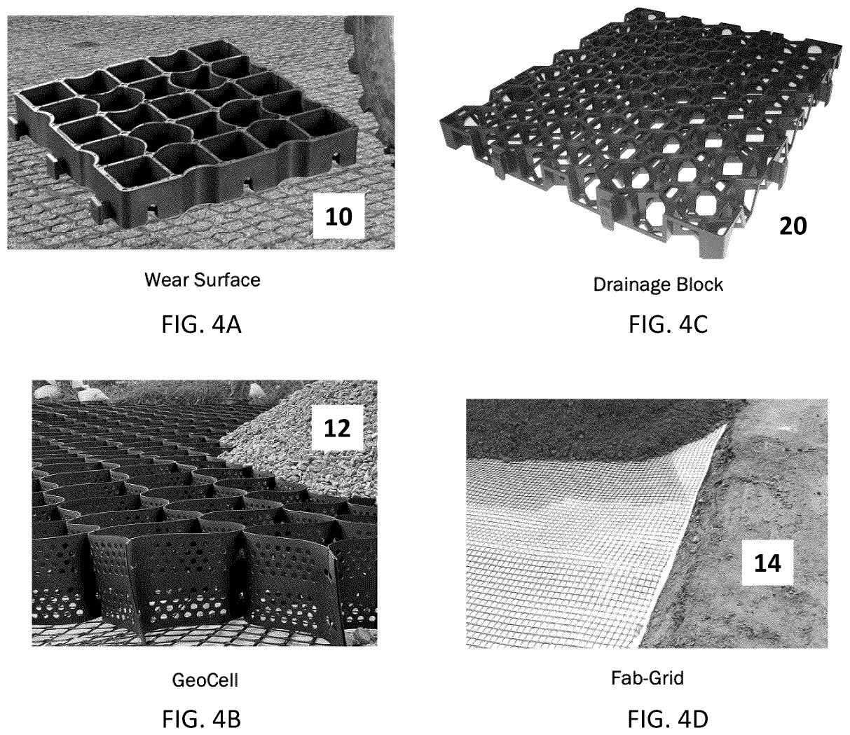

Example materials used in the construction of the drainage systems are shown in FIGS. 4A-D. The wear surface 10 is constructed from heavy-duty blocks (FIG. 4A), such as the Ecoraster® E50 ground reinforcement system (see attached technical specification sheet for additional details). According to embodiments of the invention, the wear surface 10 is filled with sand and is optional in all embodiments described herein.

The cellular confinement layer 12 is constructed from perforated strips of durable polyethylene (FIG. 4B). An example system includes BASELOK™ Geocells (see attached technical specification sheets for additional details) held together with BASELOK™ Cable Locks (see attached technical specification sheets for additional details). In embodiments of the invention, the cellular confinement layer 12 has a height of up to about 10 inches, such as up to about 2, 3, 4, 6, or 8 inches.

Drainage blocks 20 are capable of providing a avoid space of approximately 90% (FIG. 4C). In an embodiment, the drainage blocks are R-Tank XD storage panels (see attached technical specification and installation sheets for additional details). In embodiments, the drainage blocks 20 are covered in a woven geotextile fabric, such as M200 woven monofilament geotextile fabric (see attached technical specification sheet for additional details), to prevent sand and other sediment from entering the blocks. In other embodiments, a non-woven geotextile fabric is used to cover the drainage blocks 20. In an embodiment of the invention, drainage channels 21 are formed by stacking drainage blocks 20. In embodiments, multiple drainage blocks 20 are stacked vertically, such as 2, 3, 4, 5, 6, 7, or 8 blocks. In embodiments, each drainage block 20 has a height of about 2 inches. In embodiments, multiple rows of drainage blocks 20 are stacked to create a drainage layer of the desired height, such as up to about 12 inches, such as up to about 4, 6, 8, or 10 inches.

An example fabric coated geo-grid 14 used in an embodiment of the invention (FIG. 4D) is the BASELOK™ FABGRID (see attached technical specification sheet for additional details). Alternative products may be used in the invention.

A watertight liner 22 forms the bottom layer of the drainage system, according to an embodiment of the invention. The watertight liner may be a PVC liner, such as the EPT XTRM PLY PVC liner (see attached technical specification sheet for additional details). In embodiments of the invention, the watertight liner is sandwiched between layers of non-woven geotextile fabric, such as the Mirafi® 180N needle-punched non-woven geotextile fabric (see attached technical specification sheet for additional details).

1. A drainage system comprising:
optionally, a permeable top surface, such as polyethylene plastic or another plastic;
a cellular confinement layer;
a fabric coated geo-grid;
one or more sand or aggregate layer;
one or more geotextile fabric layer;
one or more drainage blocks; and
a watertight liner, optionally with a fabric layer disposed on either side of the liner.

2. The system of claim 1, wherein the one or more drainage blocks are located above the watertight liner, and are optionally R-Tank panels.

3. The system of claim 1, wherein the one or more drainage blocks comprise a plurality of drainage blocks arranged across the width or area of the drainage system.

4. The system of claim 1, wherein the one or more drainage blocks comprise R-Tank panels arranged in rows and/or R-Tank panels arranged in a stacked configuration.

5. The system of claim 1, wherein a first sand layer is disposed between the one or more drainage blocks and the cellular confinement layer.

6. The system of claim 1, wherein the fabric coated geo-grid is disposed between a first sand layer and the cellular confinement layer.

7. The system of claim 1, wherein a first sand layer is disposed between a geotextile fabric layer and the fabric coated geo-grid.

8. The system of claim 1, wherein the watertight liner is an HDPE or PVC liner.

9. The system of claim 1, comprising first and second geotextile fabric layers disposed above and/or below the watertight liner.

10. The system of claim 1, further comprising a woven geotextile fabric layer disposed between the one or more drainage blocks and a first sand layer.

11. The system of claim 1, wherein the cellular confinement layer is filled with sand or aggregates.

12. The system of claim 1, further comprising one or more drain pipe.

13. The system of any of claim 1, further comprising one or more sump in operable communication with one or more of the drainage blocks to remove water from the system.

14. A drainage system comprising:
optionally, a first layer comprising a wear surface;
a second layer comprising a cellular confinement system;
a third layer comprising a fabric covered geo-grid;
a fourth layer comprising sand;
a fifth layer comprising drainage blocks covered with a woven geotextile fabric; and
a sixth layer comprising a watertight liner.

15. The system of claim 14, wherein the sixth layer further comprises one or more geotextile fabric layers on either side of the liner.

16. The system of claim 14, wherein the watertight liner is an HDPE or PVC liner.

17. The system of claim 14, further comprising a woven geotextile fabric layer disposed on top of and/or along the sides of the drainage blocks.

18. The system of claim 14, wherein the fourth layer further comprises one or more drainage blocks covered in woven geotextile fabric disposed within the sand.

19. The system of claim 14, wherein two or more drainage blocks are stacked, such as the fifth layer comprising at least one layer of drainage blocks arranged side by side and disposed over one or more stacked drainage blocks.

20. The system of claim 14, wherein the watertight liner rests on or above a sloped subgrade.
